(19) United States
(12) Patent Application Publication
(10) Pub. No.: US 2013/0105274 A1
(43) Pub. Date: May 2, 2013

(54) EQUIPMENT FOR INSPECTING PERSONS AND LUGGAGE FOR ACCESSING RESTRICTED AREAS

(71) Applicants: Miquel Ángel Piera Eroles, Bellaterra (ES); Juan Jose Ramos González, Bellaterra (ES); Ignasi Pasquet Golobart, Santpedor (ES)

(72) Inventors: Miquel Ángel Piera Eroles, Bellaterra (ES); Juan Jose Ramos González, Bellaterra (ES); Ignasi Pasquet Golobart, Santpedor (ES)

(73) Assignees: Dinamic Manutenció Del Bages, S.A., Santpedor Barcelona (ES); Digital Aeronautics Engineering Services, S.L., Bellaterra, Barcelona (ES)

(21) Appl. No.: 13/583,292

(22) PCT Filed: Mar. 9, 2011
(86) PCT No.: PCT/ES2011/070156

§ 371 Date: Nov. 26, 2012

(30) Foreign Application Priority Data
Mar. 9, 2010 (EP) 10155949.0

(51) Int. Cl. B65G 37/00; G01V 5/00

(52) U.S. Cl. CPC B65G 37/00; G01V 5/00
USPC 198/348

(57) ABSTRACT

Equipment for inspecting persons and luggage for accessing restricted areas which comprises a machine for controlling the content of hand luggage, preferably an X-Ray machine; a walk through gate detector for detecting the presence of metal objects on persons; an admission conveyor for trays with luggage disposed at the entrance of an X-Ray machine; the walk through gate detector being located upstream the X-Ray machine to create a personal inspection area with access to the admission conveyor; a collection conveyor for collecting the trays containing luggage and personal objects, disposed at the outlet of the X-Ray machine; and a secondary conveyor disposed parallel to the collection tray conveyor, to re-direct the trays with suspicious luggage.

### OBJECT OF THE INVENTION

The main object of the present invention is equipment for inspecting persons and luggage for accessing restricted areas in airports and such like, wherein security must be guaranteed.

The equipment for inspecting persons and luggage for accessing restricted areas object of the present invention improves the effective capacity of these security checkpoints, improving the quality factors, such as, for example, the waiting time of passengers in queue, and the optimization of the technical resources, such as walk through gate detectors and X-Ray machines. The present equipment permits, on the one hand, the advancement of luggage and persons at a previously established pace and, on the other hand, the re-direction of the main flow of all those pieces of luggage which can slow down the regular operation of the equipment.

### BACKGROUND OF THE INVENTION

In general, airports, ports, official buildings and such like are subjected to loads of people at the entrance point which causes waiting queues at the security checkpoints, causing non-fulfilment of the quality factors defined by said bodies. Said security checkpoints are comprised of an X-Ray machine to inspect the hand luggage that the person is going to bring into the restricted area and a walk through gate detector to inspect the person himself, all of that in order to prevent the entry of weapons and explosive substances into said facilities.

These security checkpoints, when they are subjected to large passenger volumes, cause unending queues with their corresponding delays, which represents a big problem in managing the mobility of the passengers inside the airport.

The service quality offered by airports to their passengers is the result of the relationship between the processing capacity of security checkpoints and the passenger arrival curve which must take the following into account:
Passengers in transit.
Wave effect, due to the arrival of passengers en masse, and much earlier than their flights (tour operators).
Advance in arrival time of the passenger, which varies depending on the time of day and the destination.
Load between the different unbalanced security checkpoints.
Check-in efficiency.

Given the flight schedules on the busiest days, and given the characteristics of passenger arrivals, mainly the wave effect, it is necessary to guarantee that the security checkpoints provide the effective capacity to fulfil the quality factors established by the airport.

The problem of the waiting queues for passing through the security checkpoints is further complicated when a passenger or hand luggage is carrying a suspicious object, which forces stoppage of the passenger flow through the security checkpoints. The suspicious passenger or luggage must be separately inspected by an agent, temporarily blocking the access of passengers through the security checkpoints.

### DESCRIPTION OF THE INVENTION

The equipment for inspecting persons and luggage for accessing restricted areas proposed by the invention resolves the previously stated problem by minimizing the waiting queues while at the same time optimizing the technical and human resources at said security checkpoints.

To do this, and more specifically, the equipment for inspecting persons and luggage for accessing restricted areas comprises a machine for controlling the content of hand luggage, preferably an X-Ray machine, and a metal detecting device, preferably a walk through gate detector to detect the presence of metal objects on people, the additional equipment whereof comprising:
an admission conveyor provided with motorized means for moving the trays containing the person's baggage and personal objects, disposed at the entrance of the X-Ray machine, of a length between 5 and 15 metres,
the walk through gate detector being moved up ahead of the X-Ray machine to create a personal inspection area wherein the individual inspection of the person carrying a metal object can be carried out, as well as the introduction of an additional tray with the metal objects detected, on the admission conveyor, on a section before the X-Ray machine,
a collection conveyor for collecting the trays containing luggage and personal objects, disposed at the outlet of the X-Ray machine, of a length between 2 and 15 metres,
a secondary conveyor of a length between 2 and 3 metres, disposed parallel to the tray collection conveyor, right after the X-Ray machine, provided with means for transferring the trays from the collection conveyor to the secondary conveyor, in order to re-direct the trays with suspicious luggage for their additional inspection.

The person will begin the inspection process in this way, placing a tray at the beginning of the admission conveyor, whereon they will place their hand luggage and all of their personal objects, while the tray automatically advances along the admission conveyor, until its arrival at the X-Ray machine. The length of said conveyor is between 5 and 15 metres, in order to give the passenger time to place all of their personal objects thereon. The admission process is continuous given that the following passenger has to place their tray behind that of the previous passenger, and so on and so forth while the trays move along the admission conveyor.

The motorized means for moving the trays along the admission conveyor comprises a plurality of rollers provided with a rotational drive motor, where each motorized roller acts on up to 9 free rollers, by means of successive belts.

Likewise, in must be pointed out that the movement speed of the trays along the admission conveyor, determined by motorized means, is between 0.10 metres/second and 0.30 metres/second. In this manner, acting on the drive motors of the rollers, we regulate the advancement speed of the trays along the admission conveyor, and therefore the admission flow of persons, and the time they have available to place their belongings in the tray. The invention quantitatively determines the relationship between the different lengths and speeds of the motorized elements to guarantee the effective capacity of the process which is required at security checkpoints.

Once the person has placed their personal objects in the tray disposed on the admission conveyor, they must pass through the walk through gate detector for body search, in order to detect possible suspicious elements on the person himself. In the event that the person and their baggage do not contain suspicious objects, they will pass through the security checkpoint and will collect their luggage and personal objects from the tray, at the collection conveyor. This conveyor, in order to facilitate the collection of luggage and personal objects, is between 2 and 15 metres long.

The arrangement of said conveyors at the entrance and exit of the security checkpoint allows the inspection of persons and luggage to be sped up and the pace to be controlled, as stops in the main flow are not produced due to incidents or hold-ups of the passenger himself.

In the event that an incident occurs in the walk through gate detector because the person is carrying an object that has caused the alarm to go off, this person is taken aside from the main flow so as to not block the entrance of the people behind them, and directed to the personal inspection area to be inspected individually. Said personal inspection area comprises a table whereon to place the metal objects detected during this individual inspection, and a device for transferring these to the admission conveyor, on the section before the X-Ray machine. This way, the person that has set off the walk through gate detector alarm does not have to go back through said test again, and the objects detected are placed on the admission conveyor for their inspection through the X-Ray machine, without having to start over again. By proceeding in this manner, the tray with the objects detected during the individual inspection can be inserted into the flow of trays with luggage on the admission conveyor, achieving a greater proximity to the trays carrying the main luggage of the person who set off the alarm. This same person, after having passed through the individual complementary inspection, passes the security checkpoint and picks up their corresponding trays from the collection conveyor.

The previously mentioned device for transferring trays comprises a series of articulated arms provided with a plurality of wheels to facilitate movement, which are actuated by means of electric or pneumatic linear actuators which emerge from the table and move the trays towards the admission conveyor for their inspection in the X-Ray machine.

On the other hand, the collection conveyor comprises a plurality of free rotational rollers, the conveyor whereof being provided with a slight descending slope for the movement of the trays via gravity.

The trays placed on the admission conveyor are driven to the entrance of the X-Ray machine to be inspected by security personnel. In the event that the presence of suspicious objects is detected in a piece of luggage, the inspector will actuate the transfer device to direct the tray carrying the suspicious objects to the secondary conveyor. Said device comprises a series of articulated arms provided with a plurality of wheels to facilitate their movement, which are actuated by means of electric or pneumatic linear actuators, the ends whereof emerging from between the rollers of the collection conveyor, disposed at the outlet of the X-Ray machine, and which move the trays towards the secondary conveyor to be additionally inspected by security personnel.

In another embodiment, the tray transfer device, both on the admission and the withdrawal work surface, comprises a structure located below the respective work surface, on which a pushing device displaces sideways and alternatively to transfer the trays, by way of a driving mechanism. Said driving mechanism of the transfer device comprises two coplanar toothed wheels located over the structure, a chain which is fitted over both the corresponding sprockets and a swivel joint which slides along a cross rail in the direction of the movement of the pushing device, to give linear and alternative displacement.

For a better management and control of the trays containing the luggage, the admission conveyor comprises retractable retainers which emerge from between the rollers, which are actuated by electric or pneumatic linear actuators, to slow down and measure out the advancement of the trays to the entrance of the X-Ray machine. Said retractable retainers are disposed before the personal inspection area to permit the introduction of the new trays with the objects detected during the personal inspection. Likewise, the collection conveyor also comprises a retractable retainer which emerges from between the rollers, also actuated by an electric or pneumatic linear actuator to prevent the trays containing suspicious objects from being sent to the outlet of the X-Ray machine, disposed behind the device which transfers the trays to the secondary conveyor.

Finally, it must be indicated that the equipment for inspecting persons and luggage additionally comprises a conveyor belt for returning the empty trays from the final end of the collection conveyor to the starting end of the admission conveyor. Said conveyor belt or motorised roller channel for the return of empty trays, runs under the withdrawal work surface, the X-Ray machine and the admission work surface, it being envisaged with the positioning of a tray elevator, at the beginning of the admission work surface, and a stacker for the collection and supply of empty trays from the conveyor belt for returns, at the end of the withdrawal work surface.

The stacker for the collection and supply of empty trays from the conveyor belt for returns, comprises an upper window for the introduction of the empty trays by the corresponding users or operators, a separator of groups of empty trays of an established quantity, and a mechanism for the lowering of the group of trays to the conveyor belt or roller channel for returns.

The separator of groups of empty trays, comprises a couple of longitudinal tongues driven by a motor and corresponding toothed belts, which penetrate between the edges of the stacked trays for the removal of the upper trays, whose motor is governed by a programmable controller and the corresponding signals from the detections sensors of the position of the trays.

The mechanism for the lowering of the group of trays to the returns work bench, comprises a vertically displaceable platform properly guided, driven by a motor by way of the corresponding toothed belts, whose motor is governed by a programmable controller and the corresponding signals from the detection sensors of the position of the groups of trays.

To manage the quantity and traffic of trays in the equipment, the conveyor belt or motorised roller channel for returns comprises of a plurality of sensors distributed along the whole length.

The tray elevator comprises of two chain sets, located laterally over the elevator, and motorised using a motor-reducer and corresponding spiral bevel suitably positioned for the inversion of the turn, whose chains comprise a plurality of aligned hooks which catch on the edge of the trays for elevation to the admission work bench. Said tray elevator, additionally comprises a plurality of sensors to determine the position of the trays during their elevation.

The admission work bench comprises at least one longitudinal profile with a “U” shaped groove along which the lateral edges of the trays run in a guided manner with the aim of preventing them from overriding during possible accumulations in their displacement.

### DESCRIPTION OF THE DRAWINGS

In order to complement the description being carried out and with the purpose of helping towards a better understanding of the characteristics of the invention, in accordance with a preferred example of practical embodiment thereof, a set of drawing is attached as an integral part of said description, wherein the following, in an illustrative and non-limitative character, has been represented:

FIG. 1.—Shows a general perspective view of the equipment for inspecting persons and luggage, duly assembled and functional.

FIG. 2.—Shows a perspective view of the admission conveyor at the entrance of the X-Ray machine, wherein the section where new trays coming from the personal inspection area are introduced can be observed.

FIG. 3.—Shows a perspective view similar to the previous one, without the closure panels of the personal inspection area wherein the make-up of the device for transferring trays to the admission conveyor can be observed.

FIG. 4.—Shows a perspective view of the device for transferring the trays to the admission conveyor, also lacking the rollers of the conveyor, with the arms duly sloped to transfer the tray.

FIG. 5.—Shows a perspective view of the tray collection conveyor at the outlet of the X-Ray machine, wherein the secondary conveyor for re-directing the trays carrying suspicious objects for their additional inspection can be observed.

FIG. 6.—Shows a perspective view of the device for transferring the trays from the collection conveyor to the secondary conveyor, without all of the accessory elements.

FIG. 7.—Shows a view similar to the previous one but with the transfer device actuated in order to transfer the tray to the secondary conveyor.

FIG. 8.—Shows a complete lateral view of the inspection equipment of persons and luggage, with the conveyor belt for the transportation of the trays and the passage of roller channel for the lower return of the groups of trays, in which it is possible to see the distribution of the tray elevator and position sensors.

FIG. 9.—Shows a detailed perspective view of a section of the admission work surface, in which another version of the tray transfer device is installed, shown in detail in the following figure.

FIG. 10.—Shows a lateral view of the tray transfer device in which it is possible to see the two positions of the pushing device.

FIG. 11.—Shows a perspective view of the transfer device in which it is possible to see the toothed wheels and the chain.

FIG. 12.—Shows a detailed perspective view of the transfer device in which it is possible to see the swivel joint that connects one point of the chain with the pushing device, using a cross rail.

FIG. 13.—Shows a perspective view of the final end of the withdrawal work surface without its enclosure guards, in which it is possible to see the motorised roller channel and the stacker for the collection and supply of empty trays to the motorised roller channel.

FIG. 14.—Shows a detailed perspective view of the tray stacker without its enclosure guards, and part of the structure, in which it is possible to see the separator and the lowering mechanism.

FIG. 15.—Shows a detailed perspective view of a section of the admission work surface in which it is possible to see the positioning of the longitudinal profile for guiding the trays.

FIG. 16.—Shows a detailed view of the profile in the previous figure.

FIG. 17.—Shows a perspective view of the tray elevator, in which it is possible to see the different elements of which it is composed

### PREFERRED EMBODIMENT OF THE INVENTION

In view of the figures, a preferred embodiment of the equipment for inspecting persons and luggage for accessing restricted areas which constitutes the object of this invention is described below.

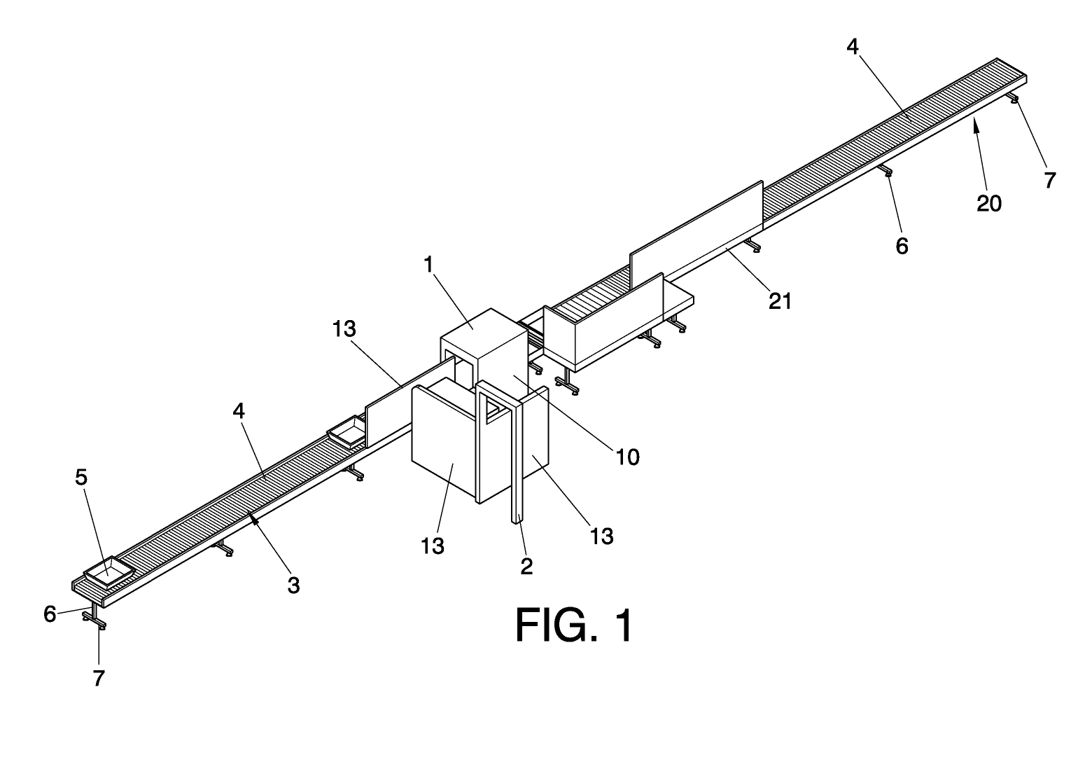

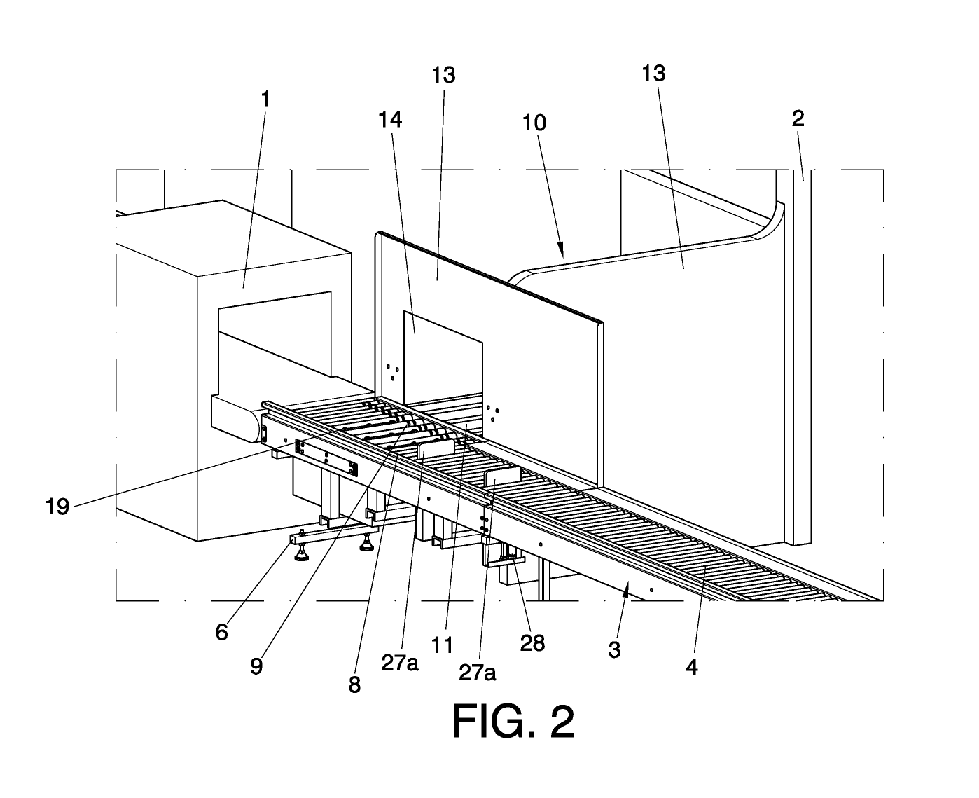

As can be observed in FIG. 1, the equipment for inspecting people and luggage for accessing restricted areas comprises an X-Ray machine (1) for inspecting luggage, and a walk through gate detector (2) for detecting the presence of metal objects on people. For the inspection of the luggage through the X-Ray machine, it has an admission conveyor (3), provided on its surface with a plurality of rollers (4) for moving the trays (5) containing the luggage and personal objects towards the entrance of the X-Ray machine (1). In the present example of embodiment, the admission conveyor (3) is 8-metres long and the displacement speed of the trays (5) is 0.10 metres/second. Likewise, the present admission conveyor (3) is constructed in three independent sections to facilitate its transferral and assembly. Each one of the admission conveyor (3) sections is equipped with a pair of support legs (6) provided with adjustable bases (7) to permit a correct levelling.

As previously indicated, the movement of the trays (5) along the admission conveyor is carried out automatically by means of the arrangement of motorized rollers (8), through a drive motor disposed inside the roller (8), which is caused to rotate, in the present example of embodiment, by nine rollers (4) by means of connection belts (9). The regulation of the drive motor of the motorized rollers (8) will determine the displacement speed of the trays (5) along the admission conveyor (3).

The inspection of persons is carried out by means of the walk through gate detector (2) disposed at a position in front of the X-Ray machine (1), with the object of creating a personal inspection area (10) provided with access to the admission conveyor (3) at a span before the entrance to the X-Ray machine, for transferring trays (5) with the objects detected during the individual inspection. In this way, the individual inspection of the person carrying a metal object in the personal inspection area does not interfere with the inspection process of the persons who are behind them.

Said inspection area comprises a table (11) provided with an extension to place a tray (5) with the metal objects detected on the person, and a device (12) for transferring said tray to the admission conveyor (3), on the section before the X-Ray machine (1). For security reasons, the inspection area is closed by means of panels (13), having been provided with an opening (14) in the panel coinciding with the admission conveyor (3), for the passage of the trays (5).

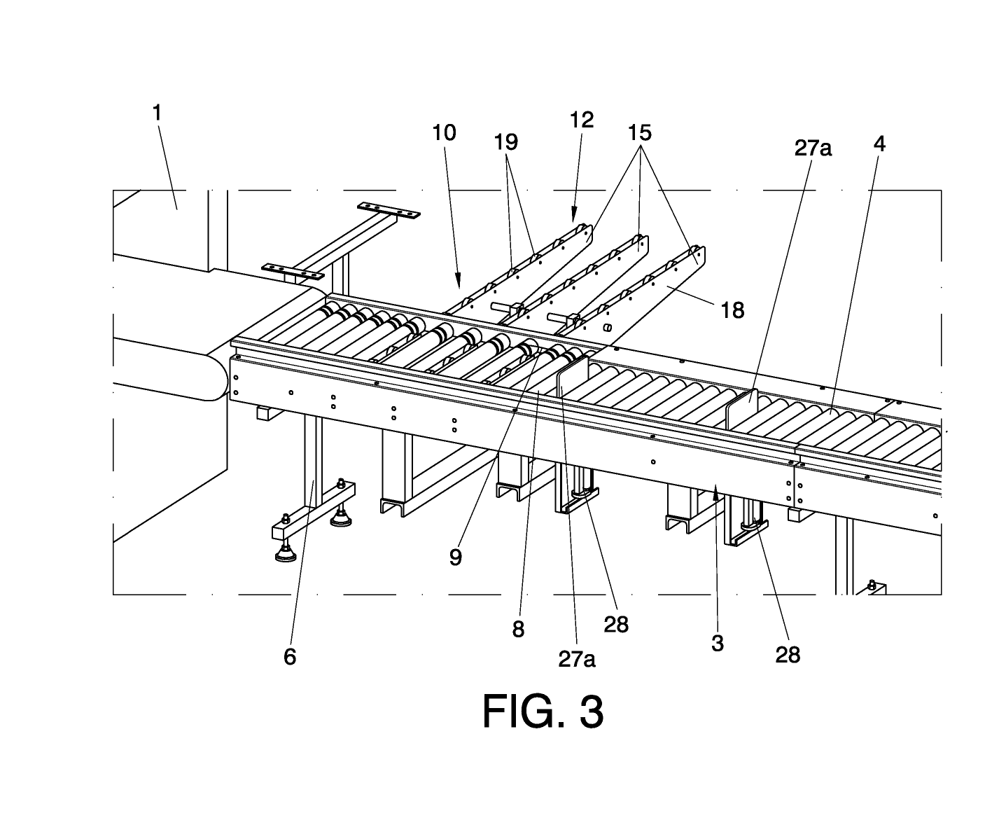

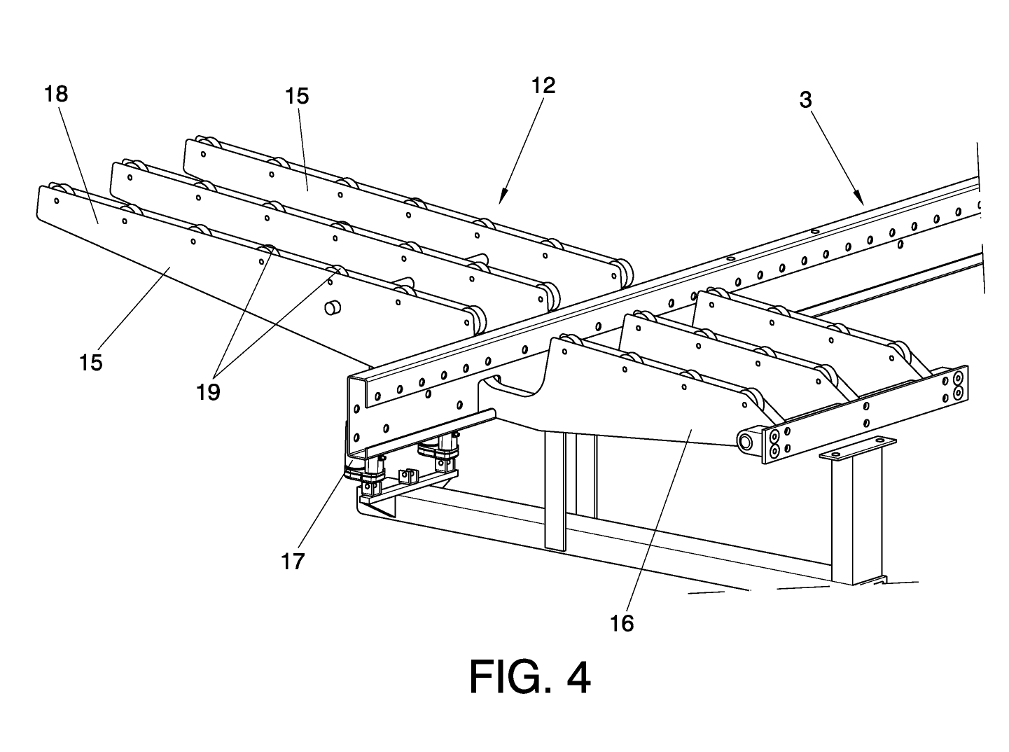

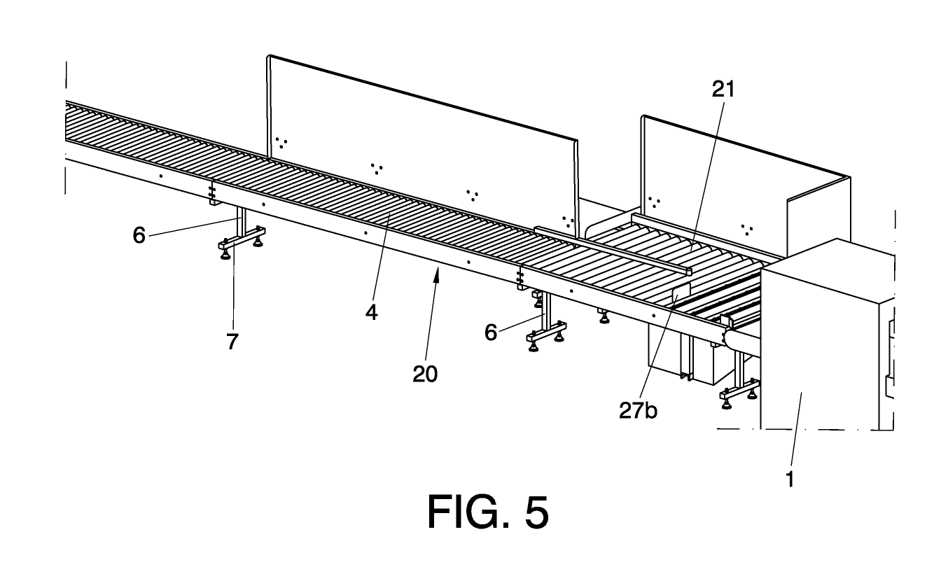

As can be observed in FIGS. 3 and 4, the device (12) for transferring trays (5) to the admission conveyor (3) from the inspection area (10) is made up of three arms (15) disposed transversally and articulated at one end (16) to the outer edge of the admission conveyor (3), actuated by an electric or pneumatic linear actuator (17), which causes the free ends (18) of the arms (15) to emerge through the table (11) and rollers (4). The upper edges of the arms (15) are provided with bearings (19) to facilitate the movement of the tray (5) towards the admission conveyor (3). Once the metal objects have been placed on the tray (5), the transfer device (12) is automatically actuated, the ends (18) of the arms (15) emerging through the table (11), for sliding the tray (5) along the bearings (19) towards the admission conveyor. In the event that there was a tray (5) occupying said position on the admission conveyor (3) at this exact moment, the transfer of the new tray (5) would be stopped until the previous one enters the X-Ray machine (1).

Once the person has been inspected, the process continues with the inspection of the luggage in the X-Ray machine. If this second checkpoint does not detect any suspicious object, the person will pick up their luggage and personal objects from the collection conveyor (20). In the present example of embodiment, the collection conveyor (20) is made up of three sections with a total length of 9 metres. Likewise, each one of the sections is equipped with a pair of support legs (6) provided with adjustable bases (7) to permit a correct levelling. The collection conveyor (20) is provided on its surface with a plurality of open rotational rollers (4) and equipped with a slight descending slope to facilitate the movement of the trays (5) via gravity.

In the cases wherein the X-Ray machine (1) detects a suspicious object in a piece of luggage, the equipment comprises a secondary conveyor (21) disposed parallel to the collection conveyor (20), right after the X-Ray machine (1), to re-direct the trays with suspicious luggage and make an additional inspection thereof. Likewise, it comprises a device (22) for automatically transferring the trays (5) from the collection conveyor (20) to the secondary conveyor (21).

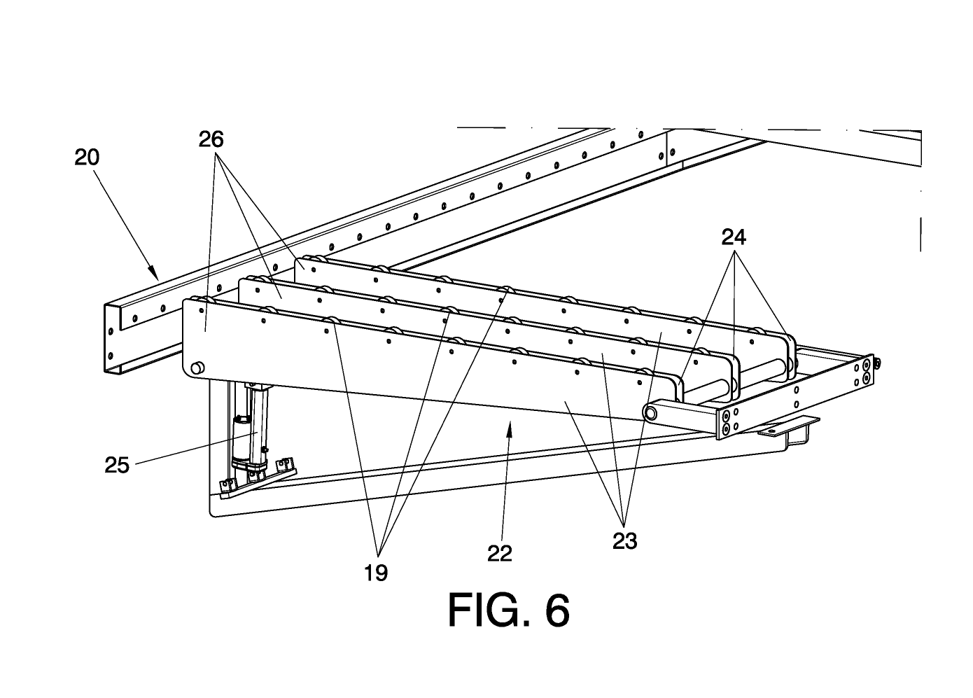

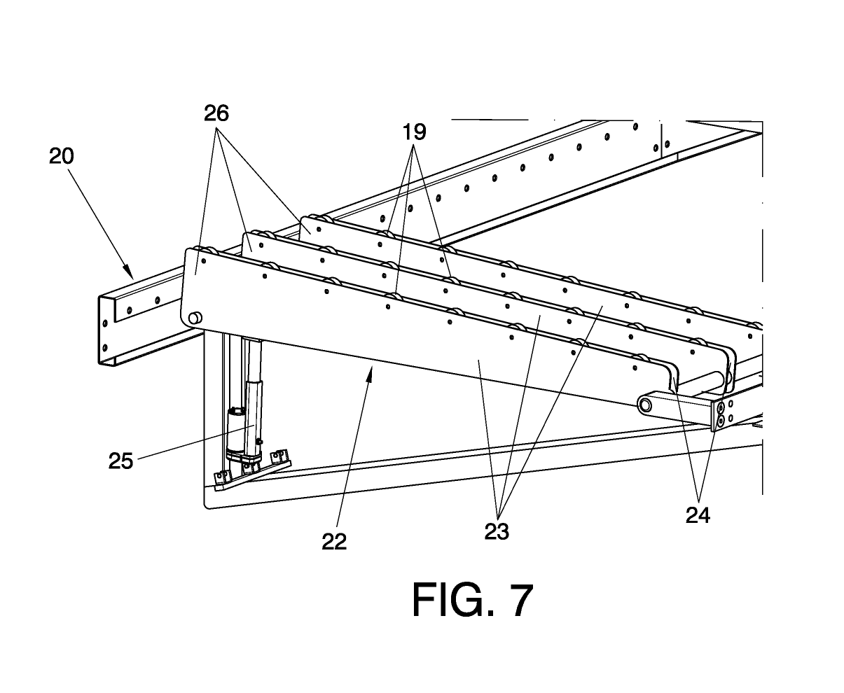

As can be observed in FIGS. 6 and 7, the transfer device (22) for re-directing the trays with suspicious luggage to the secondary conveyor (21) is made up of three arms (23) arranged transversally and articulated at one end (24) to the outer edge of the secondary conveyor (21), actuated by an electric or pneumatic linear actuator (25), which cause the free ends (26) of the arms (23) to emerge through the rollers (4). Also, the upper edges of the arms (23) are provided with bearings (19) to facilitate the sliding of the tray (5) towards the secondary conveyor (21).

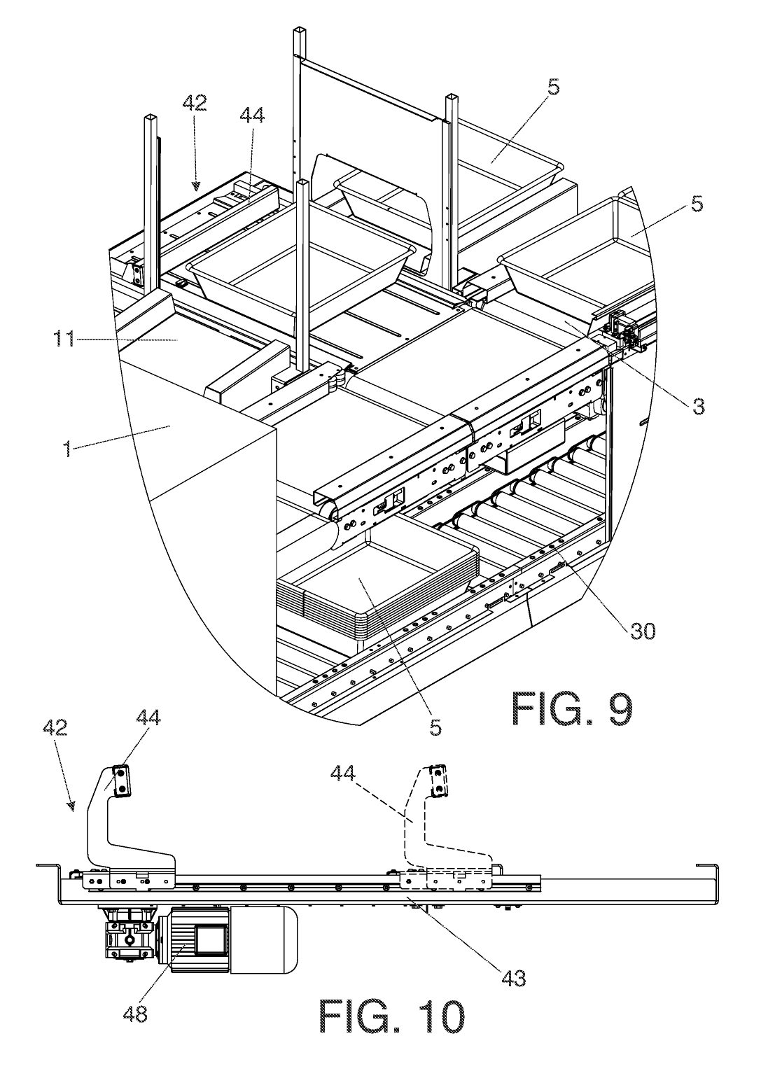

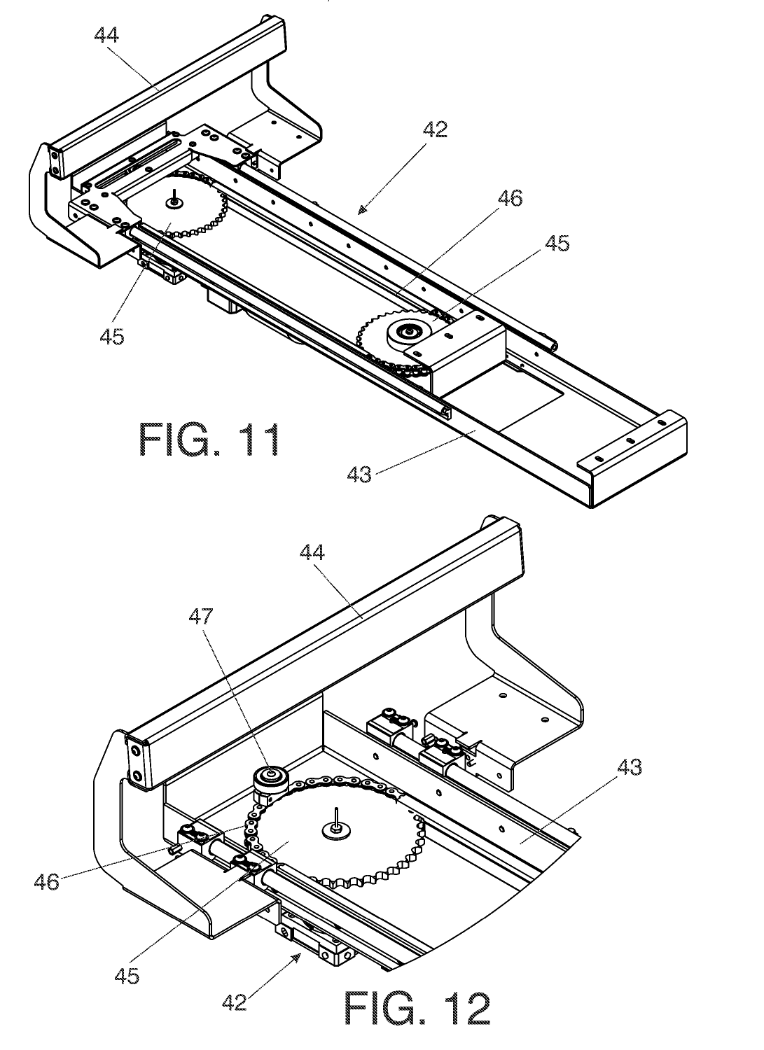

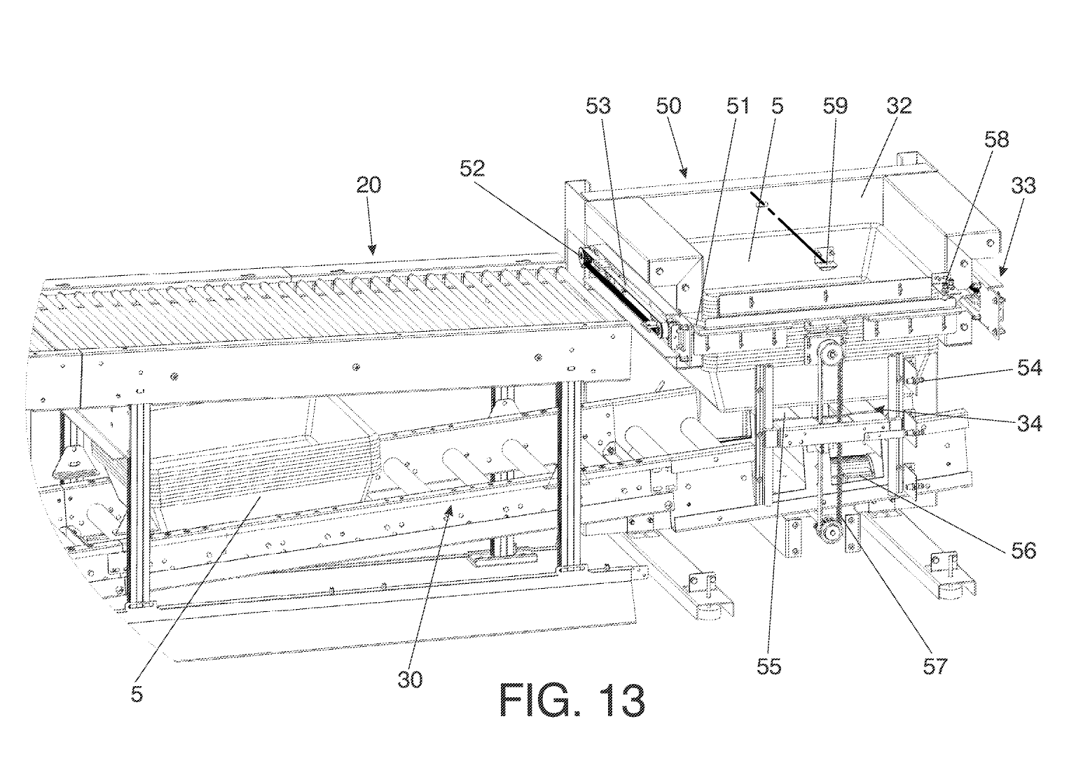

In another embodiment of the transfer device (42), represented in FIGS. 9, 10, 11 and 12, this comprises a structure (43) located under the admission work surface (3) and the withdrawal work surface (20), on which a pushing device (44) displaces sideways direction to the work surface and alternatively to transfer the trays (5), by way of a driving mechanism, which comprises of two coplanar toothed wheels (45) located over the structure (43), a chain (46) which is fitted over both toothed wheels (45) and a swivel joint (47) which connects one point of the chain (46) with the pushing device (44), to give linear and alternative displacement, using a sprocket at the axis between the toothed wheels (45). Said driving mechanism, is driven by a motor reducer (48).

Both the admission conveyor (3) and the collection conveyor (20) comprise retractable retainers (27a, 27b) which emerge from between the rollers (4) and which are actuated by electrical or pneumatic linear actuators (29) to slow down the advancement of the trays (5) at a specific moment. In the admission conveyor (3), said brake retainers (27a) are disposed on a section before the inspection area (10) to permit the entry of new trays (5) coming from the transfer device (12), as well as to be able to regulate the entry of trays to the X-Ray machine (1). In the collection conveyor (20), after the transfer device (22), it also has a retractable retainer (27b), to prevent trays (5) containing suspicious luggage from being sent to the outlet of the X-Ray machine (1).

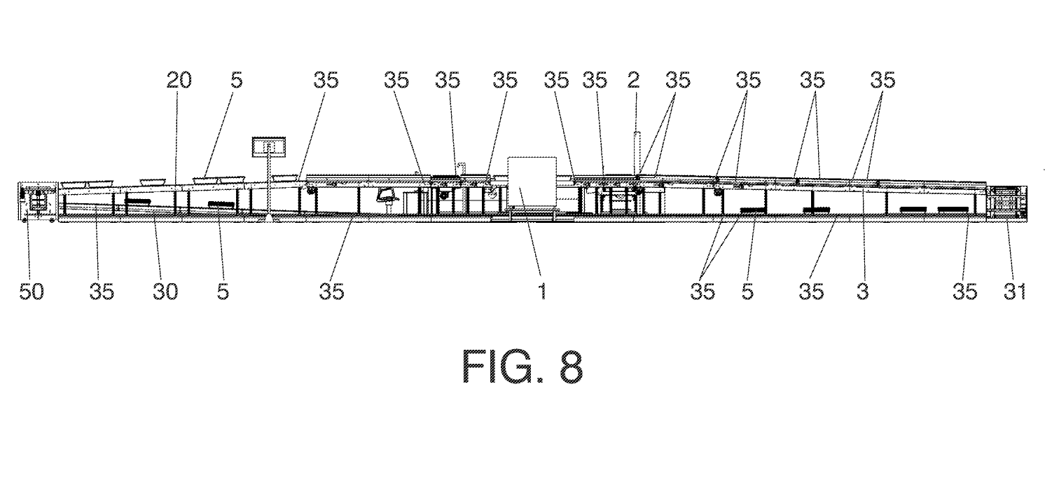

The equipment comprises a conveyor belt, materialised in the present example as a roller channel (30) for the return of the empty trays (5) from the extreme end of the withdrawal work bench (23) to the initial end of the admission work bench (3), which runs under the withdrawal work surface (20), the X-Ray machine (1), and the admission work surface (3), it being envisaged with the positioning of an elevator (31) for trays (5), at the beginning of the admission work surface (3), and a stacker (50) for the collection and supply of empty trays (5) from and to the roller channel (30), at the end of the withdrawal work surface (20). All of this represented in FIG. 8.

To allow the passage of the return roller channel (30) under the X-Ray machine (1), this has to be raised slightly. For this purpose, the passage of the trays (5) under the X-Ray machine (5) is limited by this height of elevation. In the present example of the embodiment, the elevation of the X-Ray machine (1) and the return conveyor belt (30) itself, allow the passage of groups of 10 trays (5).

The stacker (50) located at the end of the withdrawal work surface (20) comprises an upper window (32) for the introduction of the empty trays (5) by the corresponding users or operators, a separator (33) of groups of empty trays (5), and a mechanism (34) for the lowering of the group of trays (5) to the roller channel for returns (30).

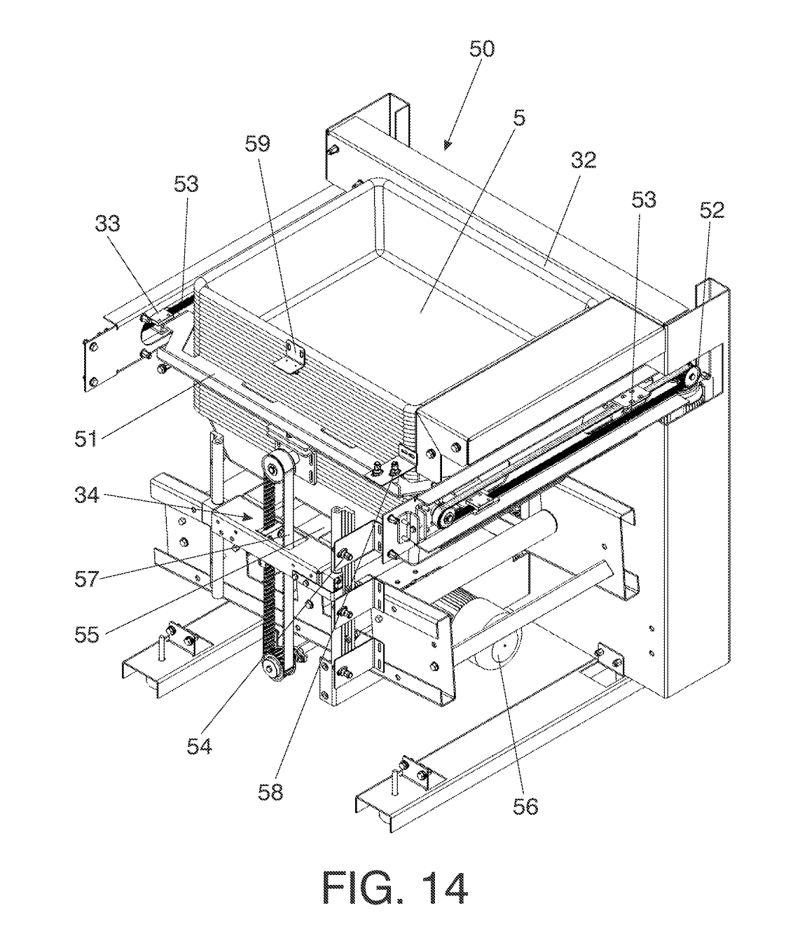

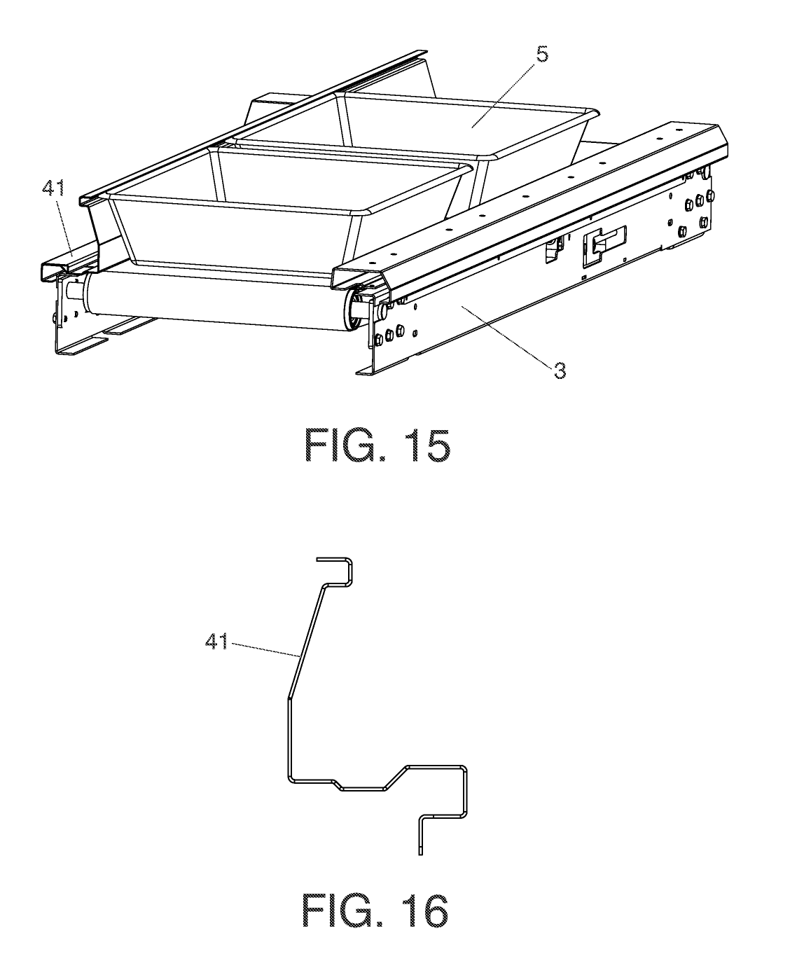

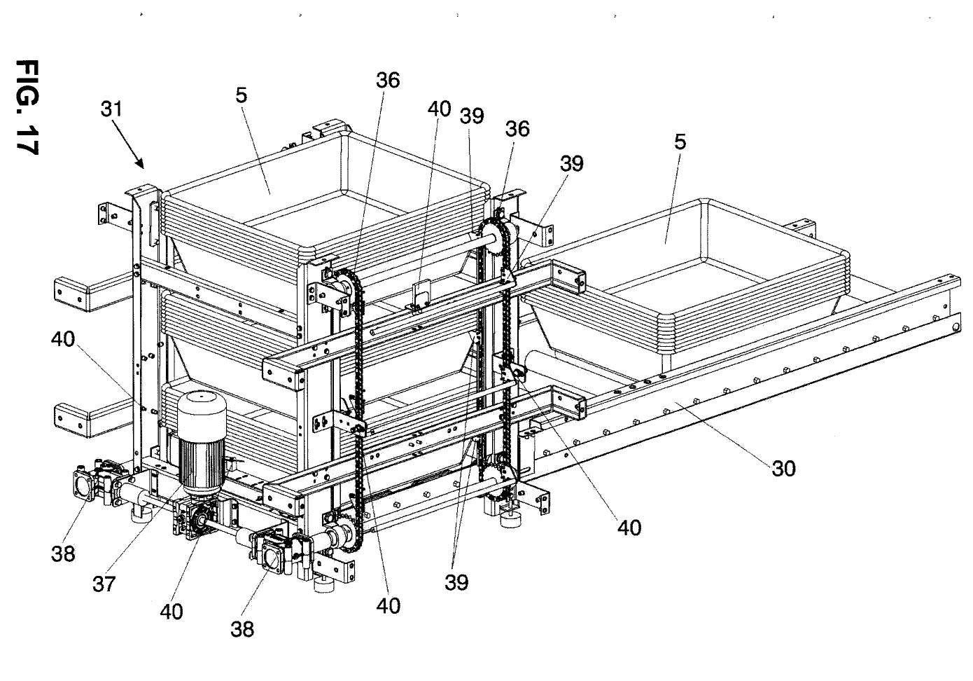

The separator (33) of groups of empty trays (5), according to FIG. 14, comprises a couple of longitudinal tongues (51), driven by a motor (52) and corresponding toothed belts (53), which penetrate between the edges of the stacked trays (5), for the removal of the upper trays (5). The motor (52) is governed by a sensor (58) which establishes the number of trays which pass under the longitudinal tongues (51).

The mechanism (34) for lowering collects the groups of separated trays (5) and deposits them on the roller channel for returns (30). For this purpose the mechanism (34) for lowering comprises a vertically displaceable platform (55) properly guided, driven by a motor reducer (56), with its corresponding toothed belts (57), whose motor is governed by the sensors (54, 59). See FIG. 14.

To manage the quantity and traffic of trays which circulate, the equipment comprises a plurality of sensors (35) distributed along the length of the admission work surface (3), withdrawal work surface (20) and conveyor belt of returns (30).

As previously mentioned, the elevator (31) is positioned at the beginning of the admission work surface (3) and is responsible for receiving the groups of trays (5) in return coming from the roller channel (30) and elevating them up to the admission work surface (3) so that the user can take them individually. For this purpose the elevator (31) comprises two chain sets (36), located laterally over the elevator (31), motorised using a motor-reducer (37) and a spiral bevel (38), whose chains (36) comprise a plurality of hooks (39) aligned so that the four chains (36), which catch on the lateral edges of the trays (5) for their elevation. Equally, the tray elevator (31), comprises a plurality of sensors (40) to determine the position of the trays (5) during their elevation.

On the other hand, indicating that the admission work bench (3) in correspondence with its interior edge, comprises a longitudinal profile (41) envisaged with a “U” shaped groove in a horizontal position, along which the lateral edges of the trays (5) run in a guided manner, with the aim of preventing them from overriding their displacement over the admission work surface (3). The positioning of said longitudinal profile (41) acts as a guide for the trays, in addition to allowing their extraction when a user who wants to abandon the inspection process with their belongings.

1. An equipment for inspecting persons and luggage for accessing restricted areas, the equipment comprising:
an X-Ray machine for controlling the content of hand luggage, having an entrance and an outlet, and
a walk through gate detector located upstream the X-Ray machine, for detecting the presence of metal objects on people, the equipment additionally comprising:
an admission conveyor provided with motorized means for moving trays intended to contain the person's luggage and personal objects, the admission conveyor being located at the entrance of the X-Ray machine and having a length between 5 and 10 metres,
a personal inspection area located between the X-Ray machine and the walk through gate detector, wherein the individual inspection of a person acknowledged in the walk through gate detector as carrying metal objects can be carried out, as well as the introduction of an additional tray with the metal objects detected, on the admission conveyor, on a section upstream the X-Ray machine, for additional inspection,
a collection conveyor, disposed located at the outlet of the X-Ray machine, and having length between 2 and 15 metres, for collecting the trays, as well as having a starting end and a final end,
a secondary conveyor between 2 and 3 metres long, located in parallel to the collection conveyor, right downstream the X-Ray machine, and
a first transferring device for redirecting from the collection conveyor to the secondary conveyor trays acknowledged in the X-Ray machine as carrying suspicious luggage, for an additional inspection.

2. The equipment of claim 1, wherein the motorized means comprises:
a plurality of motorized rollers and
a rotational drive motor for driving the motorized rollers.

3. (canceled)

4. (canceled)

5. The equipment of claim 1, wherein the personal inspection area comprises:
a table for placing the tray containing metal objects detected, and
a second transferring device for transferring the tray containing metal objects to the admission conveyor, on a section upstream the X-Ray machine.

6. The equipment of claim 5, wherein the second transfer device comprises:
a series of first articulated arms, for moving the tray containing metal objects towards the admission conveyor, and
first pneumatic or electric linear actuators, having ends emerging from the table for actuating the first articulated arms.

7. The equipment of claim 1, wherein the collection conveyor comprises a plurality of free rotational rollers, the conveyor being provided with a slight descending slope for displacing the trays via gravity.

8. The equipment of claim 1, wherein the first transferring device comprises:
a series of second articulated arms, for moving the trays carrying suspicious luggage towards the secondary conveyor, and
second electric or pneumatic linear actuators, having ends emerging from between the free rotational rollers of the collection conveyor and being located at the outlet of the X-Ray machine, for actuating the second articulated arms.

9. The equipment of claim 5, wherein the second transfer device, comprises:
a structure located under the admission conveyor and the collection conveyor
a pushing device located on the structure for displacing in a sideways direction relative to the admission conveyor and alternatively, to transfer the trays containing metal objects, and
a driving mechanism for actuating the pushing device.

10. The equipment of claim 9, wherein the driving mechanism comprises:
two coplanar toothed wheels located over the structure,
a chain which is fitted over both toothed wheels, and
a swivel joint for connecting one point of the chain with the pushing device, to give linear and alternative displacement.

11. The equipment of claim 1, wherein the admission conveyor comprises:
at least one first retractable retainer emerging from between the free rotating rollers,
a third electric or pneumatic actuator located upstream the personal inspection area to slow down the advancement of the trays to the entrance of the X-Ray machine.

12. The equipment of claim 1, wherein the collection conveyor comprises:
a second retractable retainer emerging from between the rollers, and located downstream the first transferring means, for preventing trays containing suspicious luggage from being sent to the outlet of the X-Ray machine,
a third electric or pneumatic actuator for actuating the second retractable retainer.

13. The equipment of claim 1, additionally comprising a conveyor belt for returning the empty trays from the final end of the collection conveyor to the starting end of the admission conveyor.

14. The equipment of claim 13 wherein the conveyor belt runs under the collection conveyor, the X-Ray machine and the admission conveyor, the conveyor belt comprising:
a tray elevator, located at the beginning of the admission conveyor, and
a stacker at the end of the collection conveyor for collection and supplying empty trays.

15. The equipment of claim 14, wherein the stacker comprises:
an upper window for the introduction of the empty trays
a separator for separating the empty trays in groups, and
a lowering mechanism for the lowering of the groups of trays to the conveyor belt.

16. The equipment of claim 15, wherein the separator comprises:
a couple of longitudinal tongues, for penetrating between the edges of the stacked trays for the removal of the upper trays,
a first motor and corresponding toothed belts, for driving the longitudinal tongues, and
a first sensor for governing the first motor.

17. The equipment of claim 15, wherein the lowering mechanism comprises:
a displaceable platform properly vertically guided,
a second motor and corresponding toothed belts, for driving the displaceable platform, and
second sensors for governing the second motor.

18. The equipment of claim 13, wherein the conveyor belt comprises a plurality of sensors distributed along the whole length thereof to manage the quantity and traffic of trays in return.

19. The equipment of claim 14, wherein the tray elevator comprises:
two chain sets located laterally over the elevator, and
a motor reducer and corresponding spiral bevels for motorising the chain sets,
wherein the chain sets further comprise a plurality of hooks aligned so as to catch on the edges of the trays for their elevation to the admission conveyor.

20. The equipment of claim 19, wherein the tray elevator, additionally comprises a plurality of sensors to determine the position of the trays during their elevation.

21. The equipment of claim 1, wherein the admission conveyor comprises at least one longitudinal profile with a “U” shaped groove along which the lateral edges of the trays run with the aim of preventing them from overriding.

22. The equipment of claim 2, wherein the motorized means further comprises:
free rotational rollers, and
belts successively connecting each motorized roller to up to 9 free rotational rollers, for allowing the motorized rollers actuate the free rotational rollers.
